(19) United States
(12) Patent Application Publication
(10) Pub. No.: US 2015/0070249 A1
(43) Pub. Date: Mar. 12, 2015

(54) DISPLAY SYSTEM AND REPRODUCTION CONTROL METHOD

(71) Applicants: Hidenobu HASHIKAMI, Kanagawa (JP); Osamu OGAWARA, Kanagawa (JP)

(72) Inventors: Hidenobu HASHIKAMI, Kanagawa (JP); Osamu OGAWARA, Kanagawa (JP)

(73) Assignee: Ricoh Company, Limited, Tokyo (JP)

(21) Appl. No.: 14/475,744

(22) Filed: Sep. 3, 2014

(30) Foreign Application Priority Data
Sep. 9, 2013 (JP) 2013-185964

(51) Int. Cl. G06F 3/14

(52) U.S. Cl. CPC G06F 3/1454
USPC 345/2.2

(57) ABSTRACT

A display system includes a display device and an information terminal capable of communication with the display device. The information terminal includes a setting item information acquisition unit configured to acquire setting item information relevant to control of reproduction of contents data at the display device, a display control unit configured to display a setting screen for setting a value of an item included in the setting item information, based on the acquired setting item information, and a generation unit configured to generate reproduction control information for controlling, at the display device, the reproduction of the contents data selected at the information terminal, by using the value of the item set in the setting screen.

### BACKGROUND OF THE INVENTION

1. Field of the Invention

The present invention relates to a display system of contents data, and a reproduction control method.

2. Description of the Related Art

Conventionally, there is known a technology of providing image data to a display device from an information terminal to a display device, and causing the display device to display images. In this conventional technology, values adjusted in advance are set as various setting values of the display device; however, in recent years, methods have been devised to omit the work of adjusting the setting values of the display device.

An example of a devised method that is already known, includes sending display setting information specifying a setting state relevant to the displaying of images, to a display device from an information terminal on the side that provides image data, and causing the display device to make settings according to the display setting information (Patent Document 1).

However, in the above method, the display device only sets values relevant to displaying, such as the display luminance and the color mode. Therefore, for example, in a case of causing the display device to display contents data including a plurality of images, it is difficult to set, in the display device, information relevant to the reproduction of contents data such as the order of displaying images and the display time.

Patent Document 1: Japanese Laid-Open Patent Publication No. 2010-232760

### SUMMARY OF THE INVENTION

The present invention provides a display system and a reproduction control method, in which one or more of the above-described disadvantages are eliminated.

According to an aspect of the present invention, there is provided a display system including a display device, and an information terminal capable of communication with the display device. The information terminal includes a setting item information acquisition unit configured to acquire setting item information relevant to control of reproduction of contents data at the display device, a display control unit configured to display a setting screen for setting a value of an item included in the setting item information, based on the acquired setting item information, and a generation unit configured to generate reproduction control information for controlling, at the display device, the reproduction of the contents data selected at the information terminal, by using the value of the item set in the setting screen.

According to an aspect of the present invention, there is provided a non-transitory computer-readable recording medium storing a reproduction control program executed at an information terminal capable of communication with a display device. The reproduction control program causes a computer to execute a process including acquiring setting item information relevant to control of reproduction of contents data at the display device, displaying a setting screen for setting a value of an item included in the setting item information, based on the acquired setting item information, and generating reproduction control information for controlling, at the display device, the reproduction of the contents data selected at the information terminal, by using the value of the item set in the setting screen.

According to an aspect of the present invention, there is provided a reproduction control method performed by a display system including a display device and an information terminal capable of communication with the display device. The reproduction control method includes acquiring setting item information relevant to control of reproduction of contents data at the display device, displaying a setting screen for setting a value of an item included in the setting item information, based on the acquired setting item information, and generating reproduction control information for controlling, at the display device, the reproduction of the contents data selected at the information terminal, by using the value of the item set in the setting screen.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of a system configuration of a display system according to a first embodiment;

FIG. 2 illustrates an example of a usage scene of a display system according to the first embodiment;

FIG. 3 illustrates an example of a hardware configuration of each device included in the display system according to the first embodiment;

FIG. 4 illustrates an example of a functional configuration of devices included in the display system according to the first embodiment;

FIG. 5 illustrates an example of setting item information according to the first embodiment;

FIG. 6 illustrates an example of a setting table according to the first embodiment;

FIG. 7 illustrates an example of reproduction control information according to the first embodiment;

FIG. 8 is a sequence diagram for describing operations of the display system according to the first embodiment;

FIG. 9 illustrates an example of a list screen of contents data displayed on the information terminal according to the first embodiment;

FIG. 10 illustrates an example of a setting screen displayed on the information terminal according to the first embodiment;

FIG. 11 illustrates an example of a functional configuration of devices included in a display system according to a second embodiment;

FIG. 12 illustrates an example of the setting item information according to the second embodiment;

FIG. 13 is a sequence diagram for describing operations of the display system according to the second embodiment;

FIG. 14 illustrates an example of a setting screen displayed in the information terminal of the second embodiment; and

FIG. 15 illustrates an example of a functional configuration of devices included in a display system according to a third embodiment.

### DETAILED DESCRIPTION OF THE PREFERRED EMBODIMENTS

An embodiment of the present invention includes generating reproduction control information indicating how to reproduce contents data based on values set by a user, sending the generated reproduction control information to a display device, and causing the display device to set information relevant to the reproduction of contents data.

### First Embodiment

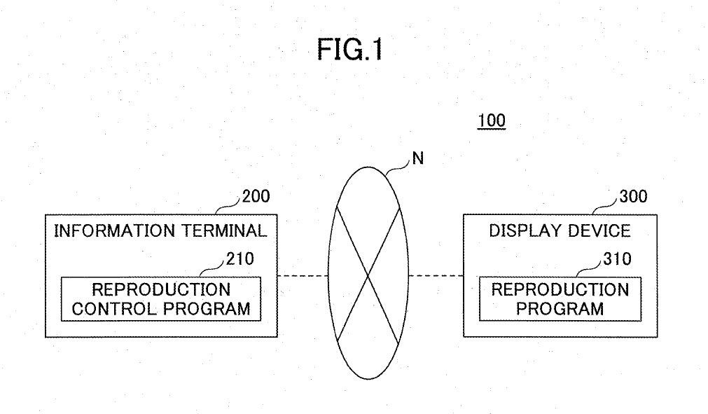

A description is given, with reference to the accompanying drawings, of a first embodiment of the present invention. FIG. 1 illustrates an example of a system configuration of a display system according to a first embodiment.

A display system 100 according to the present invention includes an information terminal 200 and a display device 300. The information terminal 200 and the display device 300 are connected by a data transmission path N such as a network.

The information terminal 200 according to the present embodiment may perform communication by a communication method conforming to specifications of, for example, 3G (3rd Generation), LTE (Long Term Evolution), and 4G (4th Generation). Furthermore, the information terminal 200 according to the present embodiment may perform communication by a communication method conforming to, for example, ZigBee and Bluetooth (registered trademark).

The information terminal 200 according to the present embodiment may be a wireless communication terminal, such as a smartphone or a mobile phone. Furthermore, the information terminal 200 according to the present embodiment may be, for example, a tablet PC (Personal Computer) or a notebook computer. The information terminal 200 according to the present embodiment may be any kind of terminal as long as communication is possible with the display device 300.

In the information terminal 200 according to the present embodiment, a reproduction control program 210 is installed. The information terminal 200 according to the present embodiment executes the reproduction control program 210 to generate reproduction control information for contents data to be displayed on the display device 300, and sends the contents data and the reproduction control information to the display device 300.

In the display device 300 according to the present embodiment, a reproduction program 310 is installed. The display device 300 according to the present embodiment executes the reproduction program 310 to display the contents data sent from the information terminal 200 based on reproduction control information.

The display device 300 according to the present embodiment is to have a display function capable of displaying the contents data based on the reproduction control information sent from the information terminal 200. Specifically, the display device 300 according to the present embodiment is, for example, a projector or a display.

In the following descriptions of the present embodiment, the operation performed by the display device 300 of displaying the contents data according to the reproduction control information, is expressed as “reproducing contents data”.

Furthermore, the contents data according to the present embodiment is, for example, image data and video data. The image data that is the contents data is, for example, image data of a single image, or image data of a plurality of images. The contents data according to the present embodiment may be any kind of data as long as the contents data can be displayed by the display device 300.

In the following description of the present embodiment, the contents data reproduced by the display device 300 is referred to as contents data to be reproduced, and other contents data, such as contents data stored in a predetermined storage area, is simply referred to as contents data.

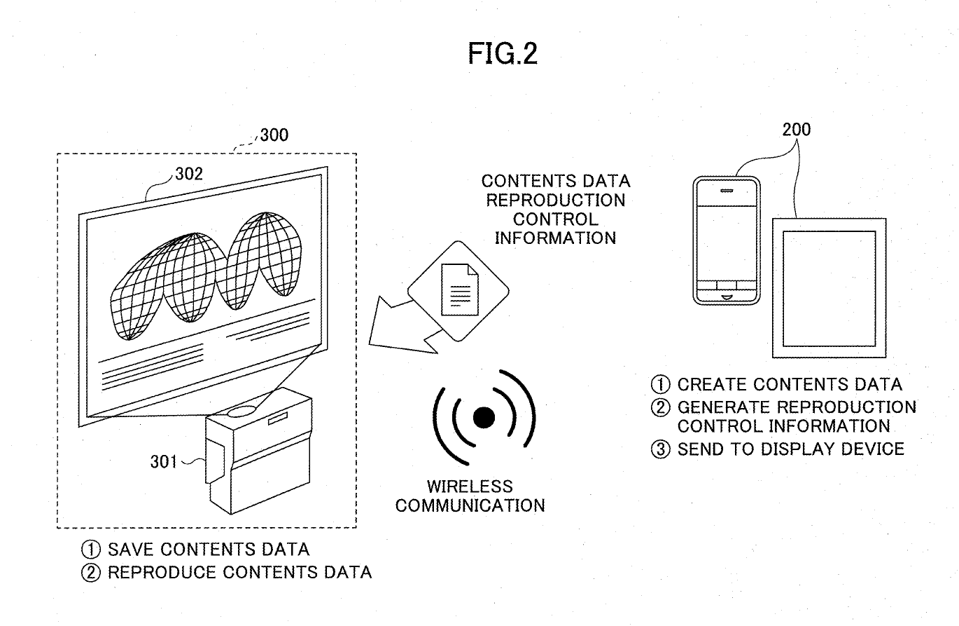

In the following, a description is given of a usage scene of the display system 100 according to the present embodiment, with reference to FIG. 2. FIG. 2 illustrates an example of a usage scene of a display system according to the first embodiment.

In the example of FIG. 2, the information terminal 200 is a smartphone or a tablet PC, the display device 300 includes a projector 301 and a screen 302, and the display system 100 is, for example, a digital signage.

When a user makes a setting of the method of reproducing contents data to be reproduced, the information terminal 200 according to the present embodiment generates reproduction control information of contents data to be reproduced based on this setting. Then, the information terminal 200 sends the contents data to be reproduced and the reproduction control information to the projector 301. The projector 301 saves the received contents data to be reproduced in a storage unit and reproduces the contents data to be reproduced according to the reproduction control information.

In the display system 100 according to the present embodiment, once the user sends the contents data to be reproduced and the reproduction control information to the display device 300, it is possible to continuously reproduce the contents data to be reproduced according to the desired setting.

That is to say, when the display system 100 according to the present embodiment is applied to a digital signage, etc., the contents data is automatically reproduced as desired by the user, and therefore the user is spared of the trouble of having to set the display order of the contents data and the switching of the contents data, every time.

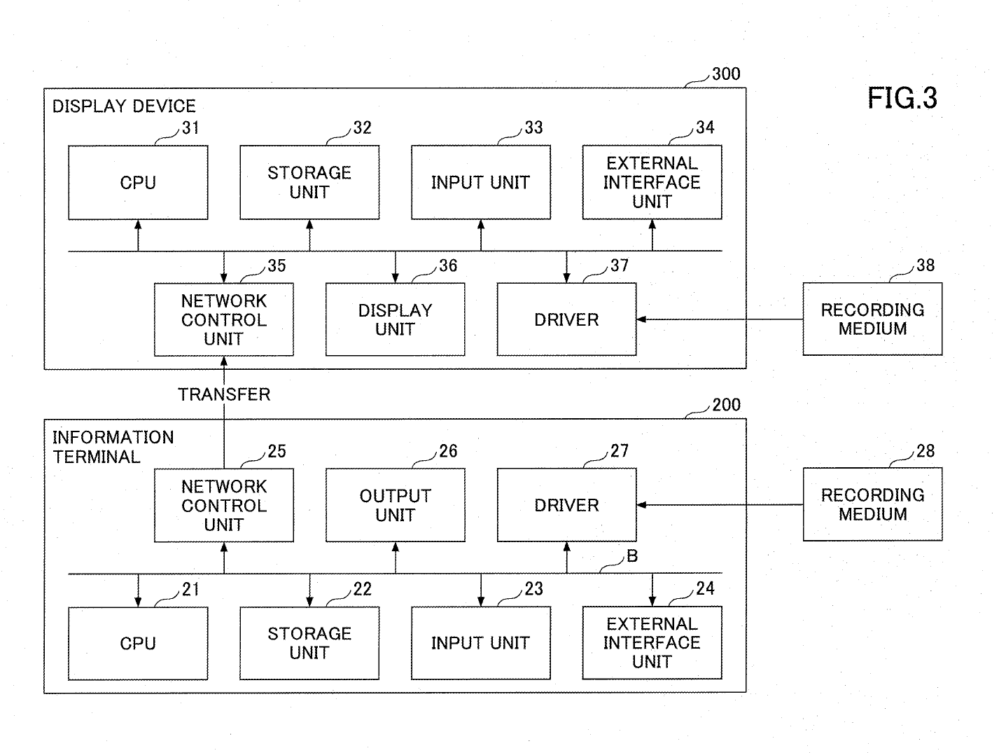

Next, a description is given of a hardware configuration of the devices included in the display system 100 according to the present embodiment, with reference to FIG. 3. FIG. 3 illustrates an example of a hardware configuration of each device included in the display system 100 according to the first embodiment.

The information terminal 200 according to the present embodiment includes a CPU (Central Processing Unit) 21, a storage unit 22, an input unit 23, an external interface unit 24, a network control unit 25, an output unit 26, and a driver 27, which are connected to each other by a bus B1.

The CPU 21 controls various operations of the information terminal 200. The storage unit 22 stores various kinds of information relevant to operations and calculations of the information terminal 200, and various programs executed by the information terminal 200. The input unit 23 is used for inputting various signals and information. The input unit 23 may have a display function such as a touch panel. Furthermore, the input unit 23 according to the present embodiment may be, for example, a pointing device or a keyboard.

The external interface unit 24 according to the present embodiment is, for example, a USB (Universal Serial Bus) memory or a NFC (Near Field Communication). The network control unit 25 includes a modem and LAN card, and is used for connecting to a network. The output unit 26 is used for outputting various kinds of information from the information terminal 200. The output unit 26 according to the present embodiment may be, for example, a display, or a transmission unit for sending various kinds of data to an external device.

The reproduction control program 210 according to the present embodiment is at least one of various programs for controlling the information terminal 200. The reproduction control program 210 is provided, for example, by being distributed in a recording medium 28 or by being downloaded from a network. As the recording medium 28 recording the reproduction control program 210, various types of recording media may be used, including a recording medium for electrically or magnetically recording information such as a CD-ROM, a flexible disk, or a magnet-optical disk, or a semiconductor memory for electrically recording information such as a ROM or a flash memory.

Furthermore, when the recording medium 28 recording the reproduction control program 210 is set in the driver 27, the reproduction control program 210 is installed in the storage unit 22 from the recording medium 28 via the driver 27. The reproduction control program 210 downloaded from a network is installed in the storage unit 22 via the network control unit 25.

The storage unit 22 stores the installed reproduction control program 210, and also stores necessary files and data. The CPU 21 realizes various processes as described below, according to the reproduction control program 210 stored in the storage unit 22.

The display device 300 according to the present embodiment includes a CPU 31, a storage unit 32, an input unit 33, an external interface unit 34, a network control unit 35, a display unit 36, and a driver 37, which are connected to each other by a bus B2.

The CPU 31 controls various operations of the display device 300. The storage unit 32 stores various kinds of information relevant to operations and calculations of the display device 300, various programs executed by the display device 300, and contents data reproduced by the display device 300. The input unit 33 is used for inputting various signals and information. The input unit 33 is, for example, an operation member for operating the display device 300.

The external interface unit 34 according to the present embodiment is, for example, a USB (Universal Serial Bus) memory or a NFC (Near Field Communication). The network control unit 35 controls the connection of the display device 300 to a network. The display unit 36 displays contents data for which the display device 300 has received a display instruction.

The reproduction program 310 according to the present embodiment is at least one of various programs for controlling the display device 300. The reproduction program 310 is provided, for example, by being distributed in a recording medium 38 or by being downloaded from a network. Furthermore, when the recording medium 38 recording the reproduction program 310 is set in the driver 37, the reproduction program 310 is installed in the storage unit 33 from the recording medium 38 via the driver 37. The reproduction program 310 downloaded from a network is installed in the storage unit 33 via the network control unit 35.

The storage unit 33 stores the installed reproduction program 310, and also stores necessary files and data. The CPU 31 realizes various processes as described below, according to the reproduction program 310 stored in the storage unit 33.

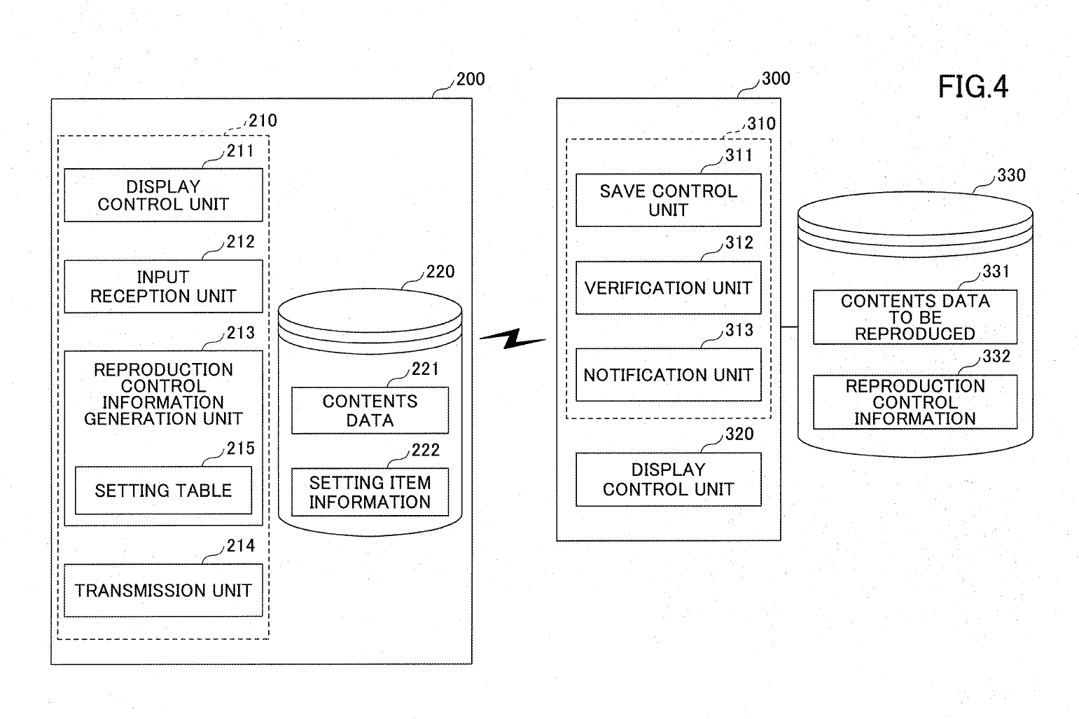

Next, a description is given of a functional configuration of devices included in the display system 100 according to the present embodiment, with reference to FIG. 4. FIG. 4 illustrates an example of a functional configuration of devices included in the display system 100 according to the first embodiment.

The information terminal 200 according to the present embodiment includes a predetermined storage area 220 provided in the storage unit 22. The storage area 220 stores, for example, contents data 221 and setting item information 222. The contents data 221 is, for example, data that can be displayed on the display device 300, such as image data and video data.

The setting item information 222 according to the present embodiment is information including items set by the user in the reproduction control information, and a range of setting values for each item. That is to say, the setting item information 222 according to the present embodiment is information relevant to controlling the reproduction of the contents data 221 in the display device 300; more specifically, information including information indicating the type of item relevant to controlling the reproduction and information indicating the range of setting values of each item. The setting item information 222 is determined in advance according to, for example, the performance and specifications of the display device 300. In the present embodiment, it is assumed that the setting item information 222 that is determined in advance according to the specifications, etc., of the display device 300, is stored in the storage unit 22.

Note that in the following descriptions, information indicating the information of items in the setting item information 222 is simply referred to as items, and information indicating the range of setting values of each item is simply referred to as a setting range.

Furthermore, the information terminal 200 according to the present embodiment includes a display control unit 211, an input reception unit 212, a reproduction control information generation unit 213, and a transmission unit 214.

The display control unit 211 according to the present embodiment displays, on a display which is the output unit 26 of the information terminal 200, a list screen of the contents data 221 and a setting screen for setting a value of the item included in the setting item information 222.

The input reception unit 212 according to the present embodiment receives a selection of the contents data 221 selected in the list screen displaying a list of the contents data 221. In the present embodiment, the contents data 221 selected in the list screen of the information terminal 200 is sent to the display device 300 as contents data to be reproduced 331 to be reproduced at the display device 300. Furthermore, the input reception unit 212 according to the present embodiment receives input of a setting value in a setting screen for setting a value of the item included in the setting item information 222.

The reproduction control information generation unit 213 according to the present embodiment generates reproduction control information 332 based on information included in the reproduction contents data. Specifically, the reproduction control information generation unit 213 according to the present embodiment holds a setting table 215 in which the items included in the reproduction control information 332 and values set for each item are associated with each other. The reproduction control information generation unit 213 refers to the setting table 215 and generates the reproduction control information 332 according to a predetermined format.

In the present embodiment, the items included in the setting item information 222 are part of the items included in the reproduction control information 332. That is to say, the reproduction control information 332 according to the present embodiment includes values that the user has set for items included in the setting item information 222. Details of processes by the reproduction control information generation unit 213 according to the present embodiment are described below.

The transmission unit 214 sends the contents data to be reproduced 331 and the reproduction control information 332 that has been generated, to the display device 300.

In the information terminal 200 according to the present embodiment, the contents data 221 is described as being stored in the storage unit 22; however, the present invention is not so limited. For example, the contents data 221 may be stored in a portable recording medium that can be read by the information terminal 200, or may be stored in an external device that can communicate with the information terminal 200.

The display device 300 according to the present embodiment includes a save control unit 311, a verification unit 312, and a notification unit 313. Furthermore, the display device 300 according to the present embodiment includes a display control unit 320 that controls the display with respect to the display unit 36.

Furthermore, the display device 300 according to the present embodiment includes a storage area 330 storing the contents data to be reproduced 331 sent from the information terminal 200 and the reproduction control information 332. Note that the storage area 330 according to the present embodiment may be, for example, provided in the storage unit 32 included in the display device 300, or in a portable recording medium that can be read by the display device 300. Furthermore, the storage area 330 may be provided in an external device that can communicate with the display device 300.

The save control unit 311 according to the present embodiment stores the contents data to be reproduced 331 and the reproduction control information 332 received from the information terminal 200, in the storage area 330. Furthermore, when the save control unit 311 according to the present embodiment receives an instruction to reproduce the contents data to be reproduced 331 from the information terminal 200, the save control unit 311 sets, in the display device 300, values of the items included in the reproduction control information 332.

The verification unit 312 verifies whether the contents data to be reproduced 331 can be reproduced in the display device 300, based on the reproduction control information 332. Details of processes by the verification unit 312 are described below. The notification unit 313 sends a notification of the verification result to the information terminal 200.

In the following, a description is given of the generation of reproduction control information by the reproduction control information generation unit 213 according to the present embodiment.

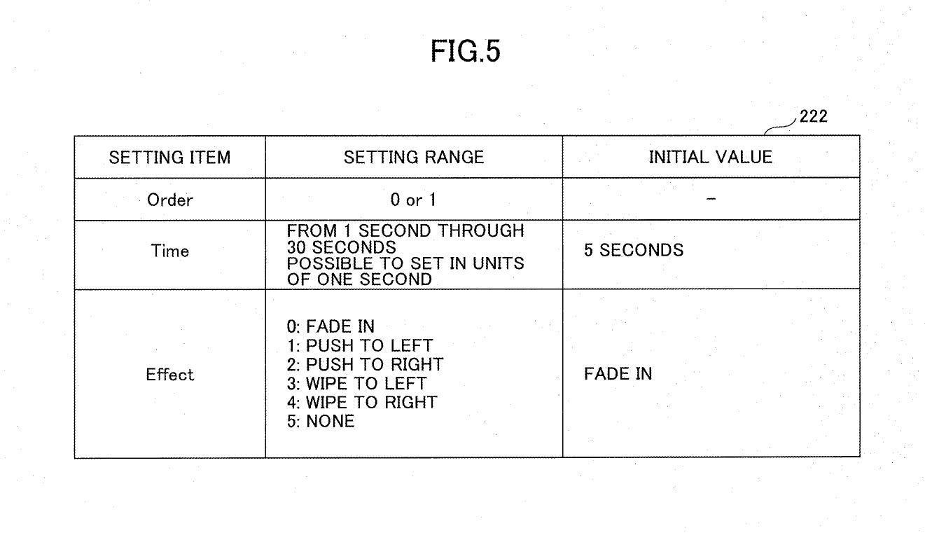

FIG. 5 illustrates an example of setting item information 222 according to the first embodiment.

The setting item information 222 according to the present embodiment includes, for example, Order, Time, and Effect, as setting items.

The Order item is an item indicating the order of reproducing the contents data 221 included in the contents data to be reproduced 331. In the present embodiment, for example, when the value of the Order item is 0, it means that the reproduction order of the contents data 221 included in the contents data to be reproduced 331 is specified. Furthermore, when the value of the Order item is 1, the reproduction order of the contents data 221 included in the contents data to be reproduced 331 becomes random. The reproduction order of the contents data 221 may be, for example, an order selected in the contents data to be reproduced 331 in the list screen of the contents data 221.

The Time item is an item indicating the reproduction time of the contents data 221 included in the contents data to be reproduced 331. In the example of FIG. 5, the Time item has a setting range of one second through 30 seconds, and this time can be set in units of one second.

The Effect item is an item indicating methods of switching the display of the contents data 221 included in the contents data to be reproduced 331. In the example of FIG. 5, the Effect item is one of the methods in a setting range for switching the display corresponding to six values 0 through 5.

In the information terminal 200 according to the present embodiment, the display control unit 211 displays a setting screen of the items, based on the setting item information 222. Details of the setting screen are described below.

In the following, consideration is given to the items, in a case where three items of contents data 221a, 221b, and 221c are selected in the stated order, from the contents data 221 stored in the storage area 220, at the information terminal 200.

In this case, the contents data to be reproduced 331 is an assembly of the contents data 221a, 221b, and 221c. Thus, when the value of the Order item is 0, the order of reproduction of the contents data 221a, 221b, and 221c is set to be the stated order. Furthermore, when the value of the Order item is 1, the reproduction order of the contents data 221a, 221b, and 221c becomes random. In the present embodiment, the value of the Order item may be set to be 0 in advance as an initial value.

As the Time item, the reproduction time of each contents data 221a, 221b, and 221c is set. Note that as the Time item, five seconds is set in advance as an initial value.

As the Effect item, for example, the method of switching the display of the display device 300 from the contents data 221a to the contents data 221b is set, when the items of contents data 221a, 221b, and 221c are set to be reproduced in the stated order. Furthermore, as the Effect item, the method of switching from the contents data 221b to the contents data 221c is set. Note that as the Effect item, fade in is set as an initial value. Fade in is a method of switching the display such that the reproduced image gradually becomes clear.

In the present embodiment, as the method of switching the display, pushing and wiping from the left to right may also be set. For example, pushing is a method of switching the display by pushing out the displayed contents data to either the left or the right to display the next contents data. Furthermore, wiping is a method of switching the display by wiping out the displayed contents data to display the next contents data.

Note that in the present embodiment, values of items included in the setting item information 222 may be set collectively with respect to all of the contents data 221 included in the contents data to be reproduced 331, or values of items may be set for each contents data 221 item included in the contents data to be reproduced 331.

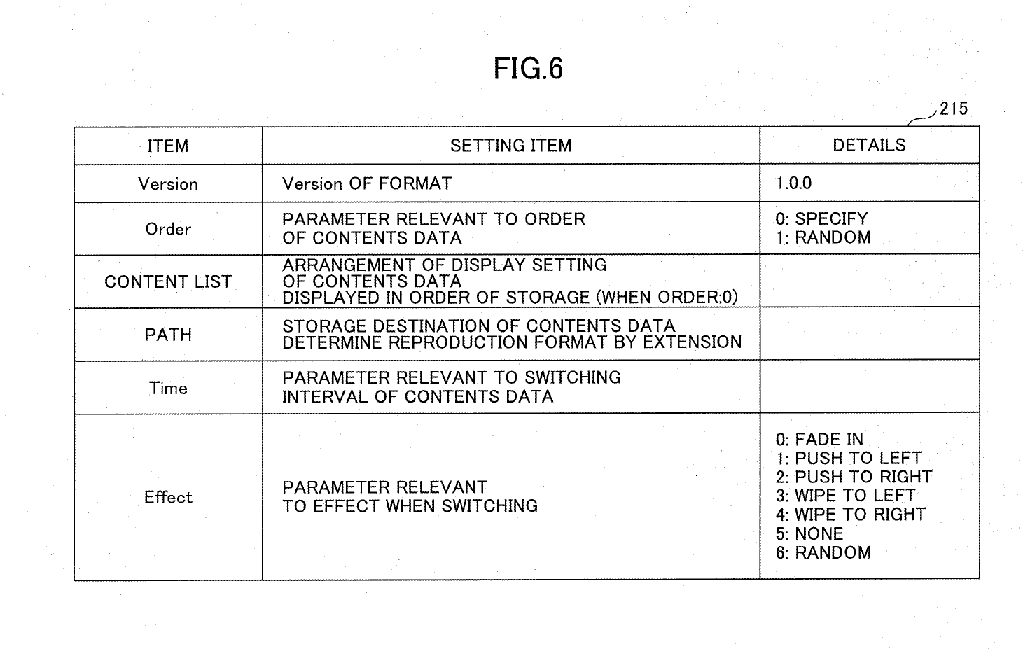

FIG. 6 illustrates an example of a setting table according to the first embodiment. The setting table 215 according to the present embodiment includes items of a Version, a Contents list, and a Path, in addition to the items of Order, Time, and Effect included in the setting item information 222.

The Version item according to the present embodiment indicates the version of the format when generating the reproduction control information 332. The value of the Version item according to the present embodiment is a value corresponding to the display device 300, in order to display the contents data to be reproduced 331 on the display device 300.

The Contents list item indicates the arrangement of the reproduction setting of the contents data. For example, the arrangement is the order in which the contents data 221 included in the contents data to be reproduced 331 is stored in the storage area 330, or the order in which the contents data 221 has been selected. In the setting table 215 according to the present embodiment, it is assumed that the Version item and the Contents list item are set in advance.

The Path item indicates the storage location of each of the contents data 221 included in the contents data to be reproduced 331. In the present embodiment, when the contents data 221 is selected, the storage location of the contents data 221 may be set as a value of the Path item in the setting table 215. Furthermore, as the value of the Path item according to the present embodiment, a file name of the selected contents data 221 may be included.

When a user sets a value of each item included in the setting item information 222, the reproduction control information generation unit 213 according to the present embodiment associates the value set by the user with a corresponding item in the setting table 215. Then, the reproduction control information generation unit 213 refers to the setting table 215, and generates the reproduction control information 332.

Note that in the present embodiment, some of the items included in the setting table 215 are assumed to be included in the setting item information 222; however, the present invention is not so limited. For example, all of the items included in the setting table 215 may be included in the setting item information 222. That is to say, it may be possible for the user to set the values of all of the items included in the setting table 215.

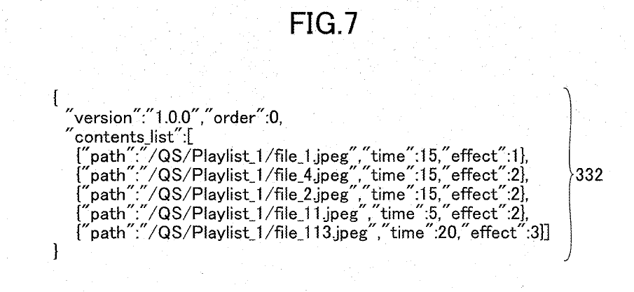

FIG. 7 illustrates an example of the reproduction control information 332 according to the first embodiment. When the values of the items in the setting table 215 are set, the reproduction control information generation unit 213 according to the present embodiment generates the reproduction control information 332 of a predetermined format including values of all of the items.

In the example of FIG. 7, the predetermined format is a JSON format. The JSON format is a light-weight data description language based on the description method of objects in JavaScript (registered trademark). The format of the reproduction control information 332 according to the present embodiment is a format that is readable by the display device 300.

In the example of FIG. 7, the value of the Version item is 1.1.0, the value of the Order item is 0, and as the value of the Contents list item, five items of the contents data 221 included in the contents data to be reproduced 331 are arranged in the order of being reproduced. Specifically, the values of the Contents list item include the value of the path, the value of the Time item, and the value of the Effect item of each contents data 221 included in the contents data to be reproduced 331.

As described above, in the present embodiment, the reproduction control information 332 including values set by the user is generated and sent to the display device 300. Thus, in the present embodiment, the method of reproduction desired by the user can be set in the display device 300.

Note that FIG. 7 illustrates an example of the reproduction control information 332 according to the present embodiment; however, the present invention is not so limited. The reproduction control information 332 may be any kind of information as long as it includes the storage location of the contents data 221 included in the contents data to be reproduced 331.

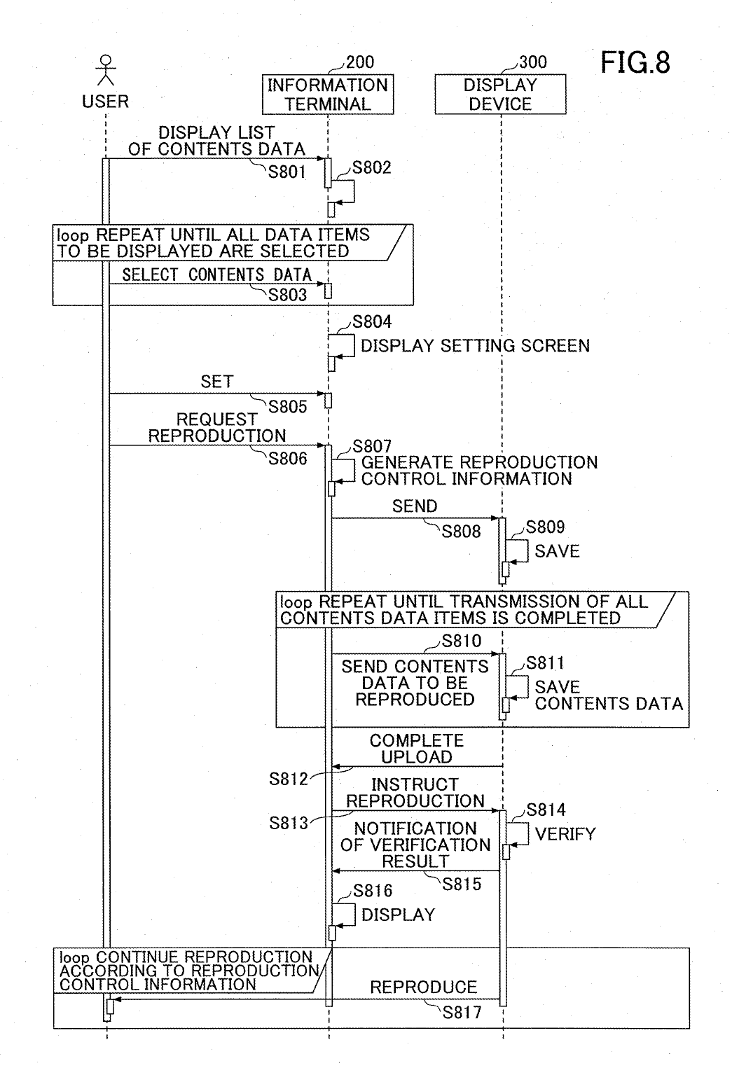

Next, a description is given of operations of the display system 100 according to the present embodiment with reference to FIG. 8. FIG. 8 is a sequence diagram for describing operations of the display system 100 according to the first embodiment.

In the display system 100 according to the present embodiment, when the user requests the information terminal 200 to display a list of the contents data 221 (step S801), the information terminal 200 displays a list screen of the contents data 221, by the display control unit 211 (step S802). Note that details of the list screen are described below.

Next, the information terminal 200 receives a selection of the contents data 221 in the list screen, by the input reception unit 212 (step S803). The information terminal 200 according to the present embodiment repeats the process of step S803 until the user finishes selecting the contents data 221. An assembly of the contents data 221 selected in step S803 becomes the contents data to be reproduced 331.

Next, the information terminal 200 refers to the setting item information 222, and displays the setting screen of items included in the setting item information 222, by the display control unit 211 (step S804). Details of the setting screen are described below.

Next, the information terminal 200 receives, by the input reception unit 212, the values of the items input in the setting screen (step S805). The input values of the items are saved in the setting table 215 in association with the corresponding items. The items included in the setting item information 222 are as described above.

Next, when a request by the user to reproduce the contents data to be reproduced 331 is received (step S806), the information terminal 200 generates the reproduction control information 332 by the reproduction control information generation unit 213 (step S807). Specifically, when the reproduction request is received, the reproduction control information generation unit 213 according to the present embodiment assigns the values of the items stored in the setting table 215 in a predetermined format and generates the reproduction control information 332.

Next, the information terminal 200 sends the reproduction control information 332 to the display device 300 by the transmission unit 214 (step S808).

When the reproduction control information 332 is received from the information terminal 200, the display device 300 stores the reproduction control information 332 in the storage area 330 by the save control unit 311 (step S809).

Next, the information terminal 200 sends the contents data to be reproduced 331 to the display device 300 by the transmission unit 214 (step S810). The display device 300 stores the contents data to be reproduced 331 in the storage area 330, by the save control unit 311 (step S811). In the present embodiment, for example, a folder corresponding to the information terminal 200 is provided in the storage area 330, and the contents data to be reproduced 331 and the reproduction control information 332 may be stored in this folder.

Next, the display device 300 sends, by the notification unit 313, a notification to the information terminal 200 indicating that the storing (uploading) of the contents data to be reproduced 331 in the storage area 330 has been completed (step S812).

When this notification is received, the information terminal 200 sends an instruction to reproduce the contents data to be reproduced 331 to the display device 300 (step S813). When the reproduction instruction is received from the information terminal 200, the display device 300 according to the present embodiment sets, in the display device 300 itself, the values of the items included in the reproduction control information 332, such that the reproduction of the contents data to be reproduced 331 is executed according to the reproduction control information 332.

Furthermore, when the reproduction instruction is received, the display device 300 verifies whether the contents data to be reproduced 331 can be reproduced according to the reproduction control information 332, by the verification unit 312 (step S814).

In the following, a description is given of the verification performed by the verification unit 312 according to the present embodiment. The verification unit 312 according to the present embodiment refers to the reproduction control information 332 and verifies whether the reproduction control information 332 is in a format that is readable by the display device 300. Furthermore, the verification unit 312 refers to the reproduction control information 332, and verifies, for example, whether the value of the Version item corresponds to the display device 300, or whether the reproduction control information 332 includes a path of each contents data 221.

The notification unit 313 according to the present embodiment sends a notification to the information terminal 200 indicating the verification result obtained by the verification unit 312 (step S815). Specifically, for example, when it is verified that the contents data to be reproduced 331 can be reproduced, the notification unit 313 according to the present embodiment may send a notification to the information terminal 200 indicating that communication is successful. When the notification is received from the notification unit 313, the information terminal 200 displays the notification result (step S816).

Furthermore, when the reproduction of the contents data to be reproduced 331 is not possible, the notification unit 313 sends a notification to the information terminal 200 indicating that the communication is unsuccessful. A case where the reproduction is not possible is, for example, a case where the reproduction control information 332 is in a format that cannot be read by the display device 300, a case where the Version does not correspond to the display device 300, or a case where the reproduction control information 332 does not include a path of the contents data 221.

In the present embodiment, for example, when the communication is unsuccessful, a message prompting to resend the contents data to be reproduced 331 may be displayed on the information terminal 200. When resending the contents data to be reproduced 331, the information terminal 200 may repeat the processes of steps S804 through S808. Furthermore, when resending the contents data to be reproduced 331, the information terminal 200 may send only the values of the items included in the contents data to be reproduced 331 and the setting item information 222, to the display device 300. In this case, the display device 300 may store the values of the items that have been resent in the corresponding items of the reproduction control information 332, and perform the verification by the verification unit 312.

After step S816, the display device 300 reproduces the contents data to be reproduced 331 according to the reproduction control information 332 (step S817).

Note that in step S8, the information terminal 200 sends the contents data to be reproduced 331 to the display device 300 after sending the reproduction control information 332 to the display device 300; however, the present invention is not so limited. For example, the information terminal 200 may associate the reproduction control information 332 with the contents data to be reproduced 331, and send both of these to the display device 300 at the same time.

Furthermore, in FIG. 8, the reproduction control information 332 is generated after the contents data 221 is selected in the list screen and values of items of the setting item information 222 are set; however, the present invention is not so limited. For example, the information terminal 200 may generate the reproduction control information 332 in parallel with the selecting of the contents data 221 and the setting of values of items of the setting item information 222.

Furthermore, the setting of values of items of the setting item information 222 may be performed, for example, when the reproduction control program 210 is activated, or immediately after receiving a request to display a list of the contents data 221. The values of items of the setting item information 222 may be set any time as long as these values are set when generating the reproduction control information 332.

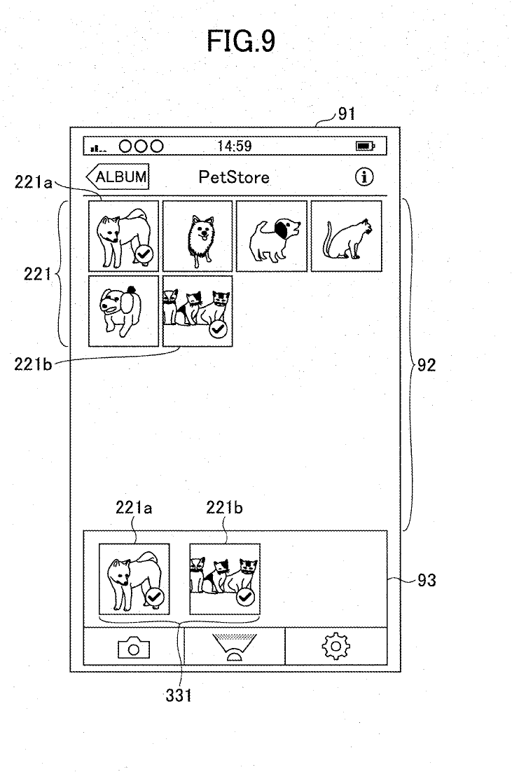

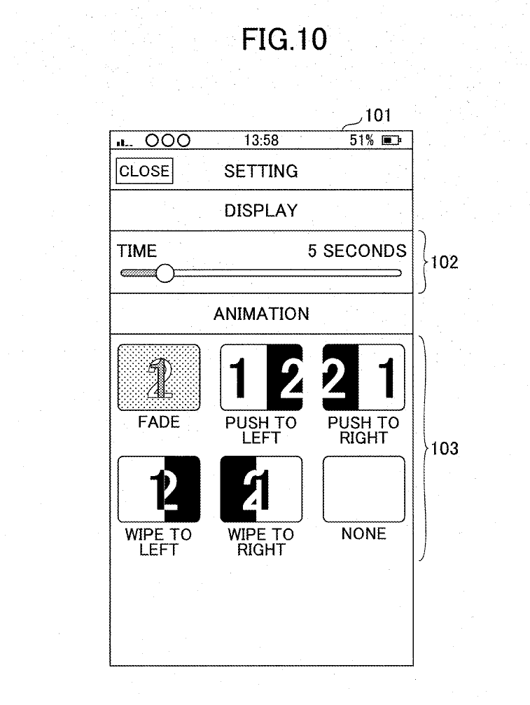

In the following, a description is given of an example of a screen displayed on the information terminal 200, with reference to FIGS. 9 and 10. FIG. 9 illustrates an example of a list screen of contents data displayed on the information terminal 200 according to the first embodiment.

A list screen 91 of contents data illustrated in FIG. 9 includes a display area 92 in which a list of the contents data 221 stored in the storage area 220 is displayed, and a display area 93 in which the contents data (to eventually become the contents data to be reproduced 331) selected in the display area 92 is displayed. Note that in the display area 92, a list of thumbnails of the contents data 221 may be displayed. Furthermore, similarly, also in the display area 93, a list of thumbnails of the contents data 221 selected in the display area 92 may be displayed.

In the example of FIG. 9, from the list of contents data 221 displayed in the display area 92 of the list screen 91, contents data 221a, 221b are selected. The selected contents data 221a, 221b are displayed in the display area 93 as the contents data (to eventually become the contents data to be reproduced 331). Furthermore, in the thumbnails of the contents data 221a, 221b of the display area 92, tick marks indicating that the data is selected, may be displayed in a superposed manner.

In the present embodiment, the contents data 221 is reproduced in the order displayed in the display area 93. That is to say, the contents data (to eventually become the contents data to be reproduced 331) of FIG. 9 is reproduced in the order of contents data 221a, 221b.

The order of the contents data 221 displayed in the display area 93 may be, for example, the order in which the contents data 221 is selected in the display area 92. The arrangement order of the contents data 221 displayed in the display area 93 may be arbitrarily changed by the user.

FIG. 10 illustrates an example of a setting screen displayed on the information terminal 200 according to the first embodiment. A setting screen 101 illustrated in FIG. 10 includes a display area 102 for setting a value of the Time item included in the setting item information 222, and a display area 103 for setting a value of the Effect item.

In the example of FIG. 10, as a user interface for setting the value of the Time item, a slider 102a is used. Furthermore, in the example of FIG. 10, as a user interface for setting a value of the Effect item, icons of animations indicating methods of switching the contents data 221 corresponding to the respective values, are used.

In the present embodiment, the user interfaces for setting the values of the items are easy to visually recognize as described above, and therefore it is easy for the user to set the values of the items.

As described above, in the display system 100 according to the present embodiment, the information terminal 200 sends, to the display device 300, the contents data to be reproduced 331 constituted by the contents data 221 selected by the user, and the reproduction control information 332 including values of the items set by the user. Furthermore, the display device 300 sets information relevant to the reproduction of the contents data to be reproduced 331 based on the reproduction control information 332 received from the information terminal 200, and reproduces the contents data to be reproduced 331 according to the reproduction control information 332.

Thus, in the present embodiment, it is possible to set, in the display device 300, information relevant to the reproduction of the contents data as desired by the user.

### Second Embodiment

A description is given, with reference to the accompanying drawings, of a second embodiment of the present invention. In the second embodiment of the present invention, item setting information is acquired from the display device, which is the point that is different from the first embodiment. Thus, in the following, only the differences between the first embodiment and the second embodiment are described, and the same functional configurations as those of the first embodiment are denoted by the same reference numerals as those of the first embodiment, and descriptions thereof are omitted.

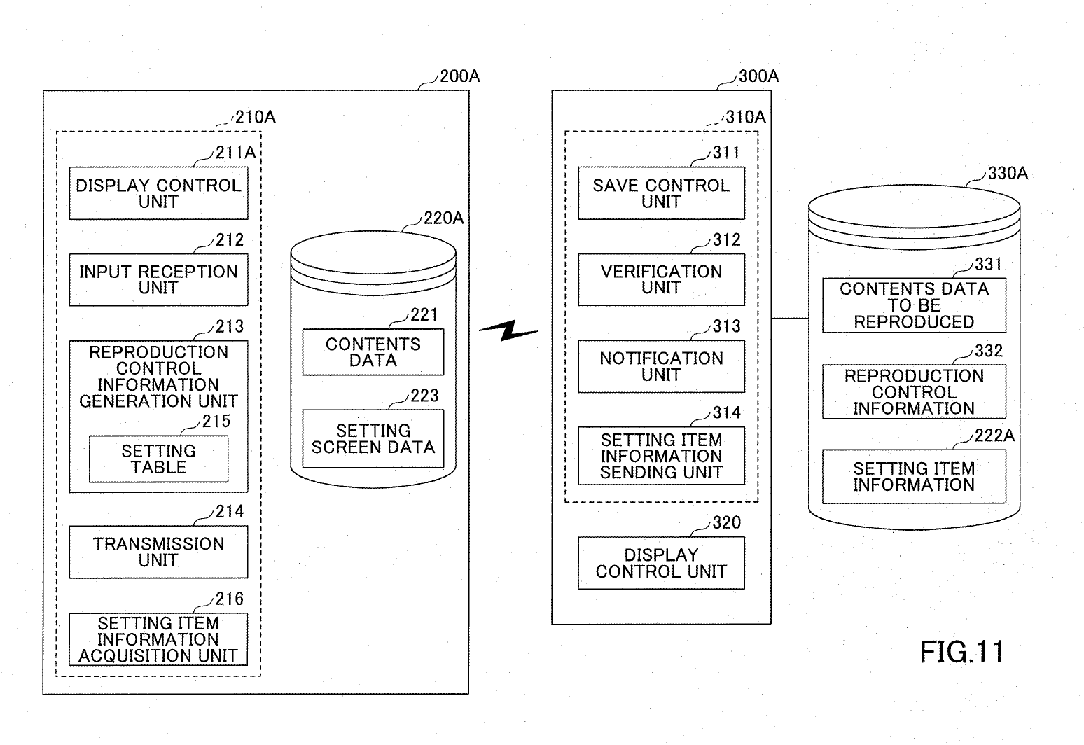

FIG. 11 illustrates an example of a functional configuration of devices included in a display system 100A according to the second embodiment.

The display system 100A according to the present embodiment includes an information terminal 200A and a display device 300A.

In the information terminal 200A according to the present embodiment, a reproduction control program 210A is installed, and the information terminal 200A includes a display control unit 211A and a setting item information acquisition unit 216.

The display control unit 211A according to the present embodiment refers to setting item information 222A, generates a setting screen with the use of text data and image data corresponding to the display control unit 211A included in setting screen data 223 described below, and displays the setting screen.

The setting item information acquisition unit 216 according to the present embodiment receives an instruction of ending the selection of the contents data to be reproduced 331 in the information terminal 200A, sends a request to the display device 300A to acquire the setting item information 222A, and acquires the setting item information 222A. When values of items included in the setting item information 222A are set, the reproduction control information generation unit 213 according to the present embodiment uses these values to generate the reproduction control information 332.

Furthermore, the information terminal 200A according to the present embodiment includes a storage area 220A. The storage area 220A according to the present embodiment stores the contents data 221 and the setting screen data 223.

The setting screen data 223 according to the present embodiment includes image data and text data that are used when displaying a setting screen for setting values of items included in the setting item information 222A. The setting item information 222A according to the present embodiment is associated with, for example, the types of items and the setting range of values of the items. More specifically, for example, the setting screen data 223 according to the present embodiment includes text data corresponding to the Time item and image data corresponding to the setting range of the Effect item.

Image data is, for example, icon data corresponding to the setting item. Icon data is, for example, an image that indicates the method of switching the display as an animation, in the setting screen for setting the Effect item. Text data includes, for example, characters for indicating the time in the setting screen for setting the Time item. For example, when a plurality of display devices 300A are included in the display system 100A, the setting screen data 223 according to the present embodiment includes the image data and the text data corresponding to the setting item information 222A of all of the display devices 300A included in the display system 100A.

Note that in the present embodiment, the setting screen data 223 is stored in the storage area 220A; however, the present invention is not so limited. For example, the setting screen data 223 may be stored in another device connected to the information terminal 200A. In this case, after acquiring the setting item information 222A, the display control unit 211A acquires the setting screen data 223 corresponding to the items included in the setting item information 222A and the setting range of the values of items, and displays the setting screen.

In the display device 300A according to the present embodiment, a reproduction program 310A is installed, and the display device 300A includes a setting item information sending unit 314. Furthermore, the display device 300A according to the present embodiment includes a storage area 330A. In the storage area 330A, the setting item information 222A is stored.

The setting item information sending unit 314 according to the present embodiment receives a request to acquire the setting item information 222A from the information terminal 200A, and sends the setting item information 222A to the information terminal 200A.

The setting item information 222A according to the present embodiment includes predetermined items included in the reproduction control information 332 that is referred to when the contents data to be reproduced 331 is reproduced in the display device 300A, and the range of values that can be set as the predetermined items.

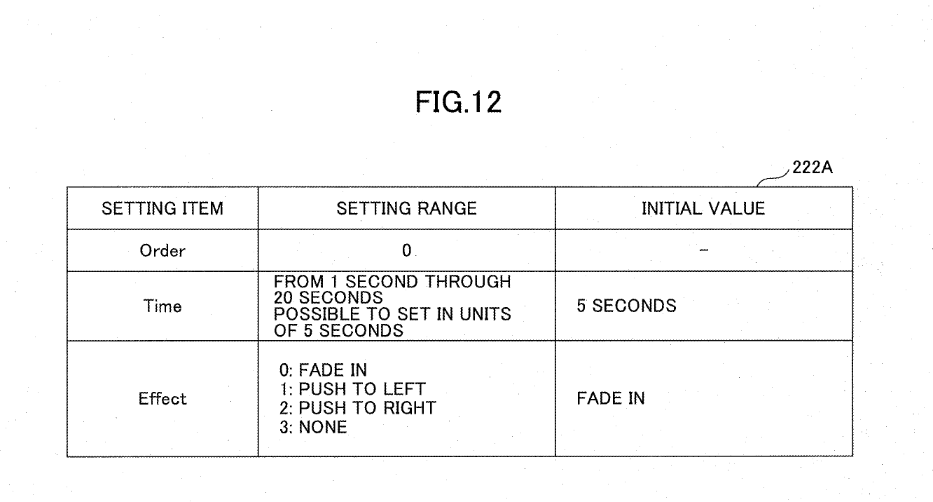

FIG. 12 illustrates an example of the setting item information 222A according to the second embodiment.

The setting item information 222A illustrated in FIG. 12 includes, for example, an Order item, a Time item, and an Effect item, as predetermined setting items.

Furthermore, the setting item information 222A illustrated in FIG. 12 includes a setting range of the values and initial values corresponding to the respective items. Note that an initial value is a value included in the setting range.

In the setting item information 222A according to the present embodiment, for example, the value that can be set as the Order item is 0, and the contents data 221 included in the contents data to be reproduced 331 is reproduced in the selected order. Furthermore, the values that can be set as the Time item are 1 second through 20 seconds at intervals of 5 seconds, and the initial value is 5 seconds. The values that can be set as the Effect item are any one of 0 corresponding to “fade in”, 1 corresponding to “push to left”, 2 corresponding to “push to right”, or 3 corresponding to “none”.

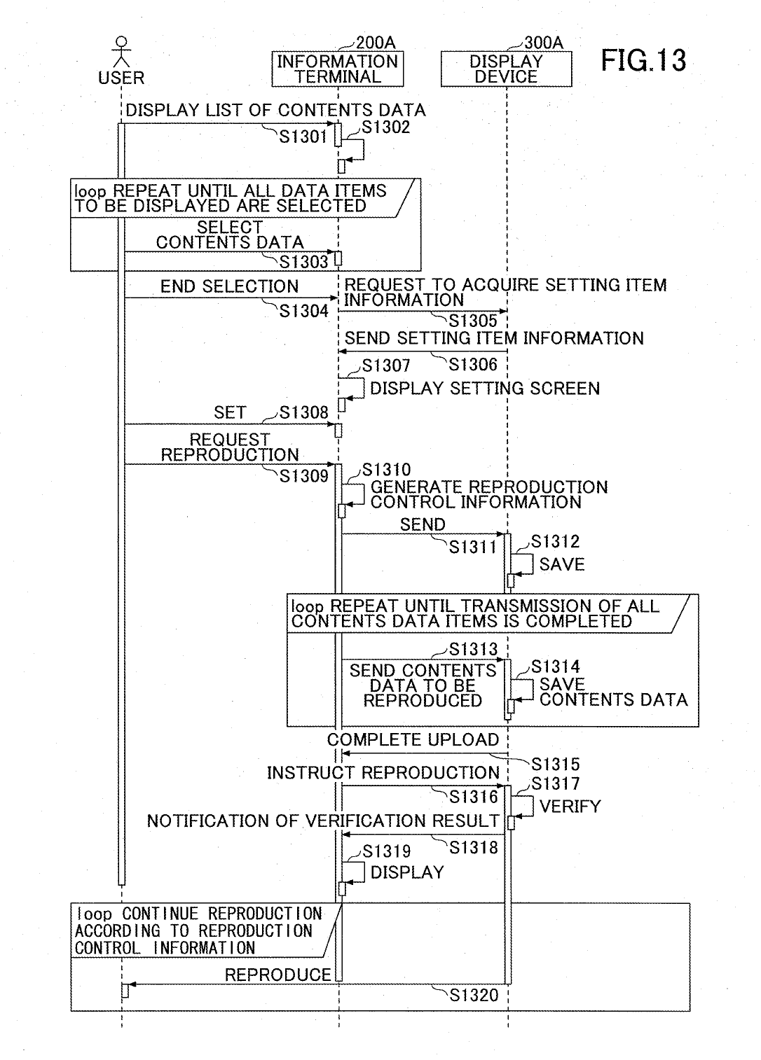

Next, a description is given of operations of the display system 100A according to the present embodiment with reference to FIG. 13. FIG. 13 is a sequence diagram for describing operations of the display system 100A according to the second embodiment.

The processes of steps S1301 through S1303 of FIG. 13 are the same as the processes of steps S801 through S803 of FIG. 8, and descriptions thereof are omitted.

When a notification indicating the end of selections of the contents data 221 by the user is received (step S1304), the information terminal 200A sends a request to acquire the setting item information 222A to the display device 300A of the display system 100 by the setting item information acquisition unit 216 (step S1305). Upon receiving this request, the display device 300A sends the setting item information 222A to the information terminal 200A (step S1306).

The information terminal 200A displays, by the display control unit 211A, a setting screen for setting items included in the setting item information 222A and the values of the items (step S1307). Details of the setting screen displayed in step S1307 are described below.

The processes of steps S1308 through S1320 are the same as the processes of steps S805 through S817 of FIG. 8, and descriptions thereof are omitted.

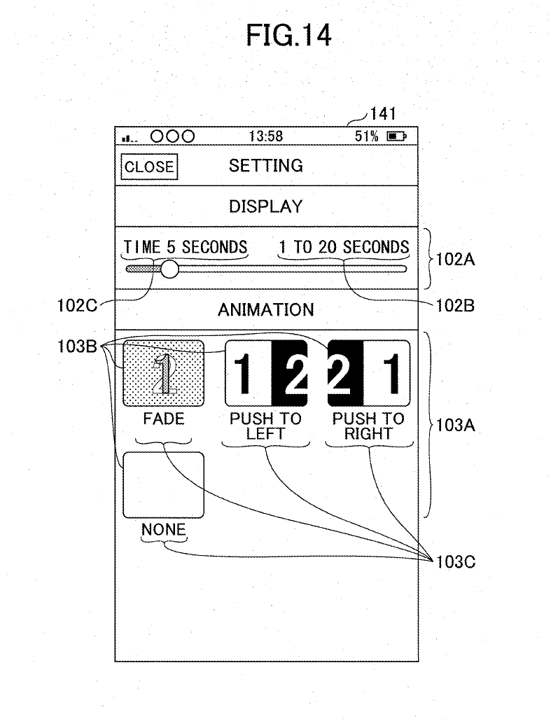

FIG. 14 illustrates an example of a setting screen displayed in the information terminal 200A of the second embodiment.

The display control unit 211A according to the present embodiment uses the image data and the text data included in the setting screen data 223, and causes the information terminal 200A to display a setting screen 141 corresponding to the items included in the setting item information 222A and the setting range.

The setting screen 141 includes a display area 102A for setting a value of the Time item included in the setting item information 222A, and a display area 103A for setting a value of the Effect item.

In the display area 102A, text data 102B, 102C corresponding to the setting range of the Time item included in the setting screen data 223, are displayed.

Furthermore, in the display area 103A, image data 103B for setting a value of the Effect item included in the setting screen data 223, and text data 103C corresponding to the image data 103B, are displayed.

Furthermore, in the present embodiment, upon receiving an instruction of the end of the selection of the contents data 221 in the information terminal 200A, a request to acquire the setting item information 222A is made to the display device 300A; however, the present invention is not so limited. For example, when a connection with the display device 300A is detected, the information terminal 200A may request to acquire the setting item information 222A.

Furthermore, in the present embodiment, the information terminal 200A displays a setting screen immediately after acquiring the setting item information 222A; however, the present invention is not so limited. When the connection with the display device 300A is detected, the information terminal 200A may acquire the setting item information 222A and save the setting item information 222A, and display the setting screen at an arbitrary timing determined by the user.

Furthermore, in the present embodiment, the setting item information 222A is acquired from the display device 300A; however, the present invention is not so limited. For example, the display device 300A may include the setting item information 222A in the SSID (Service Set Identifier) of the display device 300A, and send the SSID to the information terminal 200A.

Furthermore, for example, when the information terminal 200A according to the present embodiment fails to acquire the setting item information 222A, the information terminal 200A may send a notification indicating the failure to the display control unit 211A. In this case, the display control unit 211A may display an error message indicating the failure of the acquisition of the setting item information 222A when receiving an instruction to display the setting screen 141, or the display control unit 211A may make another request to acquire the setting item information 222A.

Furthermore, for example, the information terminal 200A according to the present embodiment may acquire the model information of the display device 300A together with the setting item information 222A, and save the model information in association with the setting item information 222A. According to this configuration, there is no need to make a request twice to acquire the setting item information 222A of the display device 300A that has already been connected.

As described above, in the information terminal 200A according to the present embodiment, based on the setting item information 222A acquired from the display device 300A, the values of the times included in the reproduction control information 332 are set. Therefore, in the present embodiment, for example, when there are a plurality of display devices 300A included in the display system 100A, the information terminal 200A can set the values of the items that can be realized in the display device 300A connected with the information terminal 200A.

### Third Embodiment

A description is given, with reference to the accompanying drawings, of a third embodiment of the present invention. In the third embodiment of the present invention, item setting information is stored in a server in the network, which is the point that is different from the second embodiment. Thus, in the following, only the differences between the second embodiment and the third embodiment are described, and the same functional configurations as those of the second embodiment are denoted by the same reference numerals as those of the second embodiment, and descriptions thereof are omitted.

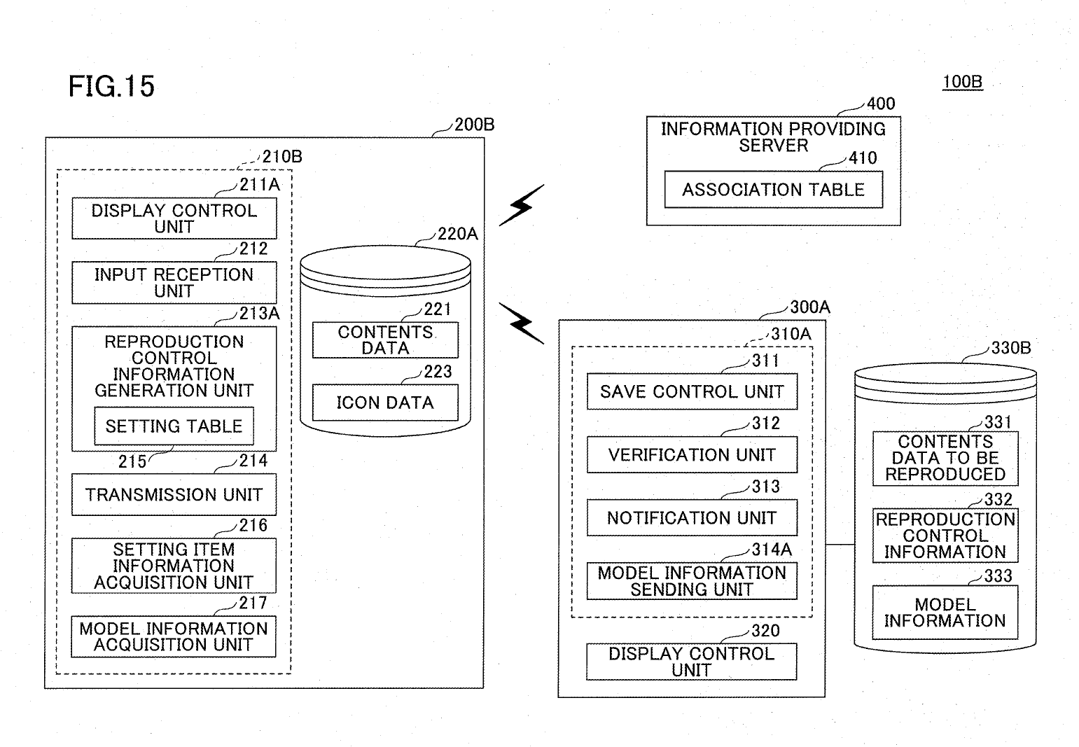

FIG. 15 illustrates an example of a functional configuration of devices included in a display system 100B according to the third embodiment.

The display system 100B according to the present embodiment includes an information terminal 200B, a display device 300B, and an information providing server 400.

In the present embodiment, the information providing server 400 stores an association table 410, in which the model information of the display device 300A and the setting item information 222A are associated with each other.

The information providing server 400 according to the present embodiment is present in a network, and provides the setting item information 222A to the information terminal 200B in response to a request to acquire the setting item information 222A from the information terminal 200B.

In the information terminal 200B according to the present embodiment, a reproduction control program 210B is installed, and the information terminal 200B includes a model information acquisition unit 217. The model information acquisition unit 217 according to the present embodiment makes a request to acquire model information to the display device 300B, and acquires model information from the display device 300B.

Furthermore, in the display device 300B according to the present embodiment, a reproduction program 310B is installed, and the display device 300B includes a model information sending unit 314A. Furthermore, the display device 300B according to the present embodiment includes a storage area 330B. The storage area 330B stores model information 333 of the display device 300B. The model information 333 according to the present embodiment is, for example, the model name or product identification information for identifying the display device 300B, which is information that is set in the display device 300B in advance.

The model information sending unit 314A according to the present embodiment receives a request to acquire model information from the information terminal 200B, reads the model information stored in the storage area 330B, and sends this model information to the information terminal 200B by the model information sending unit 314A.

In the display system 100B according to the present embodiment, for example, when a request to display a list of the contents data 221 is received, the information terminal 200B acquires the model information 333 of the display device 300B by the model information acquisition unit 217. Then, the information terminal 200B sends a request to acquire the setting item information 222A together with the acquired model information 333, to the information providing server 400 by the setting item information acquisition unit 216.

The information providing server 400 refers to the association table 410, and sends, to the information terminal 200B, the setting item information 222A associated with the model information 333 sent from the information terminal 200B.

When the information terminal 200B acquires the setting item information 222A, the information terminal 200B executes a process by the display control unit 211A.

Note that in the present embodiment, the model information 333 of the display device 300B may be sent to the information terminal 200B, as information included in the SSID of the display device 300B.

According to one embodiment of the present invention, it is possible to cause a display device to set information relevant to the reproduction of contents data.

The display system and the reproduction control method are not limited to the specific embodiments described herein, and variations and modifications may be made without departing from the spirit and scope of the present invention.

The present application is based on and claims the benefit of priority of Japanese Priority Patent Application No. 2013-185964, filed on Sep. 9, 2013, the entire contents of which are hereby incorporated herein by reference.

What is claimed is:

1. A display system comprising:
a display device; and
an information terminal capable of communication with the display device, wherein
the information terminal includes
a setting item information acquisition unit configured to acquire setting item information relevant to control of reproduction of contents data at the display device,
a display control unit configured to display a setting screen for setting a value of an item included in the setting item information, based on the acquired setting item information, and
a generation unit configured to generate reproduction control information for controlling, at the display device, the reproduction of the contents data selected at the information terminal, by using the value of the item set in the setting screen.

2. A non-transitory computer-readable recording medium storing a reproduction control program executed at an information terminal capable of communication with a display device, wherein the reproduction control program causes a computer to execute a process comprising:
acquiring setting item information relevant to control of reproduction of contents data at the display device;
displaying a setting screen for setting a value of an item included in the setting item information, based on the acquired setting item information; and
generating reproduction control information for controlling, at the display device, the reproduction of the contents data selected at the information terminal, by using the value of the item set in the setting screen.

3. The non-transitory computer-readable recording medium according to claim 2, wherein
the displaying includes displaying the setting screen by using setting screen data associated with the setting item information.

4. The non-transitory computer-readable recording medium according to claim 3, wherein
the setting item information includes information indicating a type of item included in the reproduction control information and information indicating a range of a setting value of each item included in the reproduction control information, and
the displaying includes displaying the setting screen by using the setting screen data corresponding to the type of item and the range of the setting value of each item included in the reproduction control information.

5. The non-transitory computer-readable recording medium according to claim 4, wherein
the type of item includes an item indicating a reproduction time of the contents data at the display device, and an item indicating a method of switching a display of the contents data at the display device.

6. The non-transitory computer-readable recording medium according to claim 2, wherein
the acquiring includes acquiring the setting item information from the display device.

7. The non-transitory computer-readable recording medium according to claim 2, further comprising:
acquiring model information identifying a model of the display device from the display device, wherein
the acquiring of the setting item information includes referring to a storage unit storing an association table in which the model information and the setting item information are associated with each other, and acquiring the setting item information associated with the model information.

8. A reproduction control method performed by a display system including a display device and an information terminal capable of communication with the display device, the reproduction control method comprising:
acquiring setting item information relevant to control of reproduction of contents data at the display device;
displaying a setting screen for setting a value of an item included in the setting item information, based on the acquired setting item information; and
generating reproduction control information for controlling, at the display device, the reproduction of the contents data selected at the information terminal, by using the value of the item set in the setting screen.
